(19) United States
(12) Patent Application Publication
(10) Pub. No.: US 2011/0286365 A1
(43) Pub. Date: Nov. 24, 2011

(54) Method for Connection Preservation

(75) Inventors: Renato Pinheiro Simoes, Fortaleza-CE (BR); Pier Angelo Tognini Filho, Goiania-GO (BR); Brian Scot Hillis, Centennial, CO (US)

(73) Assignee: AVAYA INC., Basking Ridge, NJ (US)

(21) Appl. No.: 12/784,941

(22) Filed: May 21, 2010

(51) Int. Cl. H04L 12/16; H04M 3/42

(52) U.S. Cl. 370/260; 379/211.01; 379/202.01

(57) ABSTRACT

A method is provided for the preservation of communication sessions that are terminated unexpectedly. The present invention detects when an ongoing communication session is (or is about to be) terminated unexpectedly by a first communication session participant. And also, the present invention takes steps to preserve the disintegration of the communication session with respect to a second communication session participant.

### FIELD OF THE INVENTION

The present invention relates to telecommunications in general, and, more particularly, to connection preservation.

### BACKGROUND OF THE INVENTION

Unexpected call termination occurs when a telephone terminal of a user terminates a phone call without a request from its user. This can result when a terminal experiences a software failure, when the terminal experiences physical distress, or when the terminal is brought into a zone with poor signal coverage.

At present, the need exists for a method for preventing unexpected telephone call termination.

### SUMMARY OF THE INVENTION

The present invention addresses this need by a two-pronged approach to connection preservation. The approach involves (a) detecting when the participation of a terminal in a communication session is disrupted and (b) taking steps to prevent disintegration of the communication session with respect to a second communication-session participant.

In particular, the present invention determines that the participation of a terminal is disrupted, for example, when one of the following triggering events occurs:
(1) Media from the terminal is lost.
(2) Media transmitted by the terminal is corrupt.
(3) A quality of service measure of the media transmitted by the terminal (e.g., latency, jitter, etc.) falls below a threshold.

Furthermore, as noted, the present invention takes steps to prevent the disintegration of the first communication session when it detects that the participation of participant in the communication session is disrupted. Specifically, the present invention puts a second participant, with whom the first participant is communicating, on hold. The second participant is put on hold until the first participant recovers and re-connects with the second participant or until a time-out period expires. In this way, the second participant is influenced to perceive its connection with the first participant as active during the temporary failure of the first participant.

In some embodiments, a conference is established in response to a request to establish a direct communication session. The establishing of the conference comprises, in some embodiments, three sub-tasks: (a) establishing a first communication session between a conference bridge and a first terminal; (b) establishing a second communication session between the conference bridge and a second terminal; and (c) bridging the first communication session with the second session. Establishing the connection between the first terminal and the second terminal as a conference, in this way, enables the second communication session to remain active when the participation of the first terminal in the communication session is disrupted.

When the participation of the first terminal in the communication session is disrupted, the second terminal is put on hold by the conference bridge. When the first terminal recovers from the disruption, a third communication session is started between the first terminal and the conference bridge. Following its establishment, the third communication session is bridged with the second communication session thereby restoring the communication between the first terminal and the second terminal without disconnecting the second terminal from the bridge.

In some embodiments of the present invention, the conference between the first terminal and the second terminal is established transparently to the first terminal. That is, the first terminal is unaware that it is communicating with the conference bridge. The transparency is achieved by substituting, unbeknownst to the parties (i.e., the first terminal and second terminal), contact information of the parties that is carried inside communication signaling with contact information for a conference call. The substitution causes the parties to connect to each other via the conference bridge rather than connect to each other directly.

For the purposes of this disclosure, the term “request to establish a direct communication session” is defined as a request which demands, requests, or results in the delivery of contact information of an endpoint device to be transmitted to the maker of the request, wherein the endpoint device is associated with an identifier of a far-end party, and wherein the far-end party is identified by the request.

For the purposes of this disclosure, the term “contact information” is defined as information which is used in establishing a communication session that is used for the transmission of real-time media. Examples of contact information include IP addresses, port numbers, codec identifications, encryption keys, bandwidth information, session name, and others. Contact information includes, but is not limited to, the streaming media initialization attributes that are identified inside Session Description Protocol (SDP) messages. (See, e.g., SDP: Session Description Protocol, RFC 4566, etc.).

It is to be understood that the above embodiments and their instances are provided to better illustrate different aspects of the present invention. They are in no way exhaustive of the full scope of the invention. The following disclosure teaches examples of some embodiments of the present invention in detail.

### BRIEF DESCRIPTION OF THE DRAWINGS

FIG. 1 depicts a schematic diagram of the salient components of the illustrative embodiment of the present invention.

FIG. 2A depicts a schematic diagram of the salient hardware components of terminal 110.

FIG. 2B depicts a schematic diagram of the salient software components of server 140.

FIG. 3 depicts a schematic diagram of the data and signal flows which are exchanged between terminal 120 and terminal 110 in accordance with the illustrative embodiment of the present invention.

FIG. 4 depicts a sequence diagram of the interactions between terminal 110, server 140, conference bridge 130, and terminal 120 which take place in the illustrative embodiment of the present invention.

FIG. 5 depicts a schematic diagram of the data flows which are exchanged between terminal 120 and terminal 110 in accordance with a first alternative embodiment of the present invention.

FIG. 6 depicts a flowchart of the execution of the salient tasks associated with the operation of the illustrative embodiment of the present invention.

FIG. 7 depicts a flowchart of the execution of the salient sub-tasks associated with the performance of task 620.

FIG. 8 depicts a flowchart of the execution of the salient sub-tasks associated with the performance of task 630.

FIG. 9 depicts a flowchart of the execution of the salient sub-tasks associated with the performance of task 650.

### DETAILED DESCRIPTION

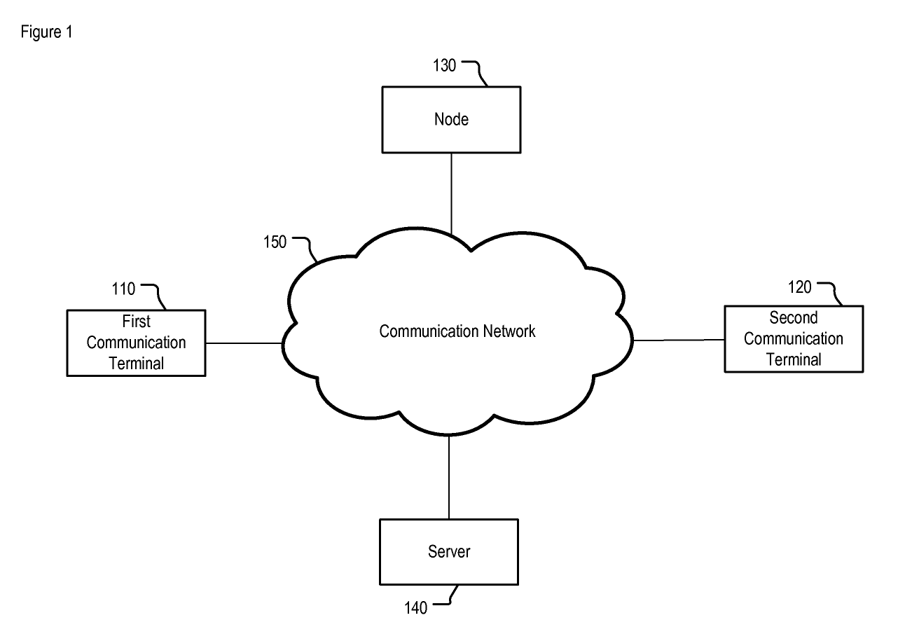

FIG. 1 depicts a schematic diagram of the salient components of the illustrative embodiment of the present invention. The illustrative embodiment comprises server 140, node 130, terminal 110, terminal 120, and network 150.

Server 140 is a Session Initiation Protocol (SIP) proxy server with enhanced connection-preservation capabilities. In operation, server 140 performs at least one of two functions: (1) connection set-up and (2) connection preservation. With regard to its connection-setting function, server 140 receives signaling from terminals 110 and 120 and uses it to establish a connection between the terminals. Specifically, in response to receiving the signaling, server 140 transmits instructions to node 130 to connect terminal 110 with terminal 120.

Server 140 can be any type of Session Initiation Protocol (SIP) server (e.g., proxy, registrar, redirect server, etc.). Furthermore, server 140 can operate according to a different communication protocol. Those skilled in the art will recognize, after reading this disclosure, that alternative embodiments of the present invention can be devised in which another communication protocol is used (e.g., SS7, H.323, etc.).

Node 130 is a communication network node which is capable of maintaining a connection with terminal 120 on behalf of terminal 110. In the illustrative embodiment, node 130 is a conference bridge. In alternative embodiments of the present invention, node 130 can be any other network node (e.g., switch, router, etc.).

In the illustrative embodiment, terminal 110 and terminal 120 are cellular telephones. Those skilled in the art will recognize, after reading this disclosure, how to make and use alternative embodiments of the present invention in which one or both of these terminals is another communication device, such as, for example, and without limitation, a smart phone, desk set telephone receiver, portable digital assistant (PDA), media streaming server, desktop computer, etc. In the illustrative embodiment of the present invention, terminals 110 and 120 use the Session Initiation Protocol (SIP). But it will be clear to those skilled in the art, after reading this disclosure, how to make and use alternative embodiments of the present invention in which any signaling protocol is used (e.g., ss7, H.323, etc.).

Network 150 is a communications network that transports signals between terminal 110, terminal 120, node 130, and server 140. In accordance with the illustrative embodiment of the present invention, network 150 is a cellular network, but it will be clear to those skilled in the art, after reading this disclosure, how to make and use alternative embodiments of the present invention in which network 150 is another type of communication network (e.g. a local area network, the Public Switched Telephone Network, the Internet, wide area network, etc.).

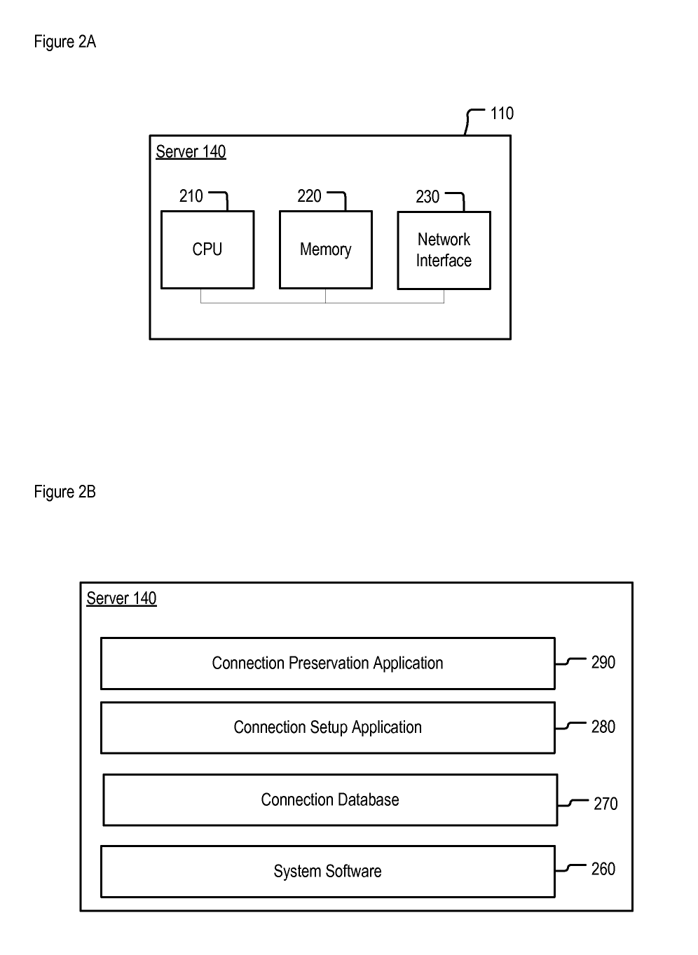

FIG. 2A depicts a schematic diagram of the salient hardware components of server 140. Server 140 comprises processor 210, memory 220, and network interface 230.

Processor 210 is a central processing unit (CPU) configured to execute computer code. It will be clear to those skilled in the art how to make and use processor 210.

Memory 220 is a storage device that is addressable by processor 210. In accordance with the illustrative embodiment of the present invention, memory 220 is random access memory (RAM). It will be clear to those skilled in the art, after reading this disclosure, how to make and use alternative embodiments of the present invention in which memory 220 is any type of volatile or non-volatile storage device.

Network interface 230 is hardware that enables server 140 to transmit and receive communications over at least one communications network. It will be clear to those skilled in the art how to make and use network interface 230.

FIG. 2B depicts a schematic diagram of the salient software components of server 140. Server 140 comprises system software 260, database 270, connection setup application 280, and connection preservation application 290.

Connection preservation application 290 is software that is operable to receive indication(s) from node 130 that the participation of terminal 110 in a communication session with terminal 120 is disrupted. Furthermore, connection preservation application 290 is operable to take action in response to the receipt of such indications.

In the illustrative embodiment of the present invention, connection preservation application 290 instructs node 130 to put terminal 120 on hold when it receives an indication that the participation of terminal 110 in the communication session with terminal 120 is disrupted. When terminal 110 recovers from the disruption, connection preservation application reconnects terminal 110 with the put-on-hold terminal 120.

Database 270 is software for receiving and storing information about communication sessions that are enhanced by the services of connection preservation application 290. In accordance with the illustrative embodiment of the present invention, database 270 comprises the following record:

TABLE 1
Exemplary record from database 270

| | |
|---|---|
| Participants | Terminal 110, Terminal 120 |
| Nodes On the Path Between the | Node 130 |
| Participants | |
| Protocol Used | SIP |
| Type of Connection | Conference Call |
| Status of Connection | Unexpectedly Terminated |
| Users Put on Hold | Terminal 120 |
| Id of Connection that is Used to Keep | Communication link B |
| the Users on Hold | |

In accordance with the illustrative embodiment of the present invention, database 270 stores seven (7) types of information. It identifies the participants in a communication session, network nodes that are on the connection path between the participants, type of protocol used, the type of communication session, status of the connection, whether terminal 120 is put on hold, and an identifier for the connection which is used to keep terminal 120 on hold. It will be clear to those skilled in the art, after reading this disclosure, how to make and use alternative embodiments of the present invention in which any item of information concerning communication sessions between terminal 110 and terminal 120 is recorded in database 270.

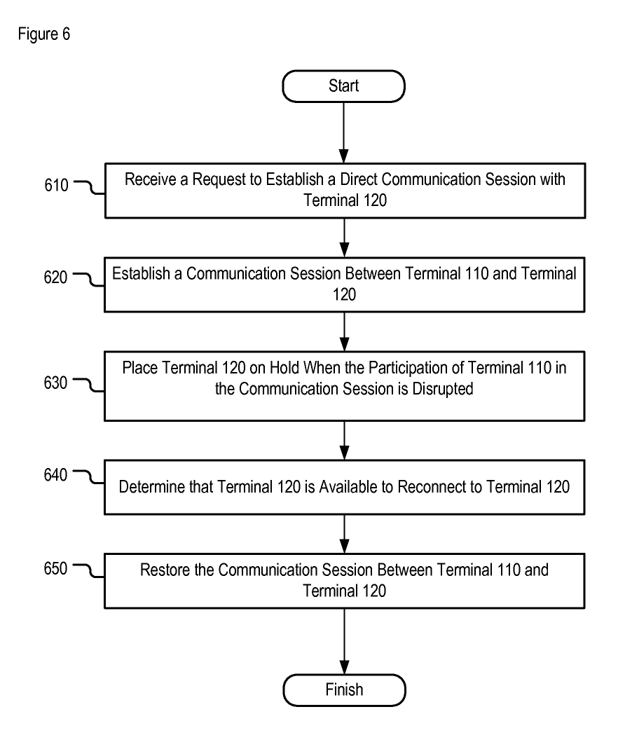

In a first alternative embodiment of the present invention, which is discussed in relation to FIG. 6, database 270 comprises the following record:

TABLE 2
Exemplary record from database 270

| | |
|---|---|
| Participants | Terminal 110, Terminal 120 |
| Nodes On the Path Between the | Switch 610, Switch 620 |
| Participants | |
| Protocol Used | SS7 |
| Type of Connection | Person-to-person call (i.e., |
| | non-conference call), connection |
| | oriented communication session |
| Status of Connection | Unexpectedly Terminated |
| Users Put on Hold | Terminal 120 |
| Id of Connection that is Used to Keep | Leg 3 |
| the Users on Hold | |

Connection setup application 280 is software for establishing communication sessions between communication terminals. In the illustrative embodiment of the present invention, connection setup application 280 receives signaling messages from terminal 110 and terminal 120. Connection setup application 280 uses the information that is contained in the signaling messages to instruct node 130 to establish a communication link between the two terminals.

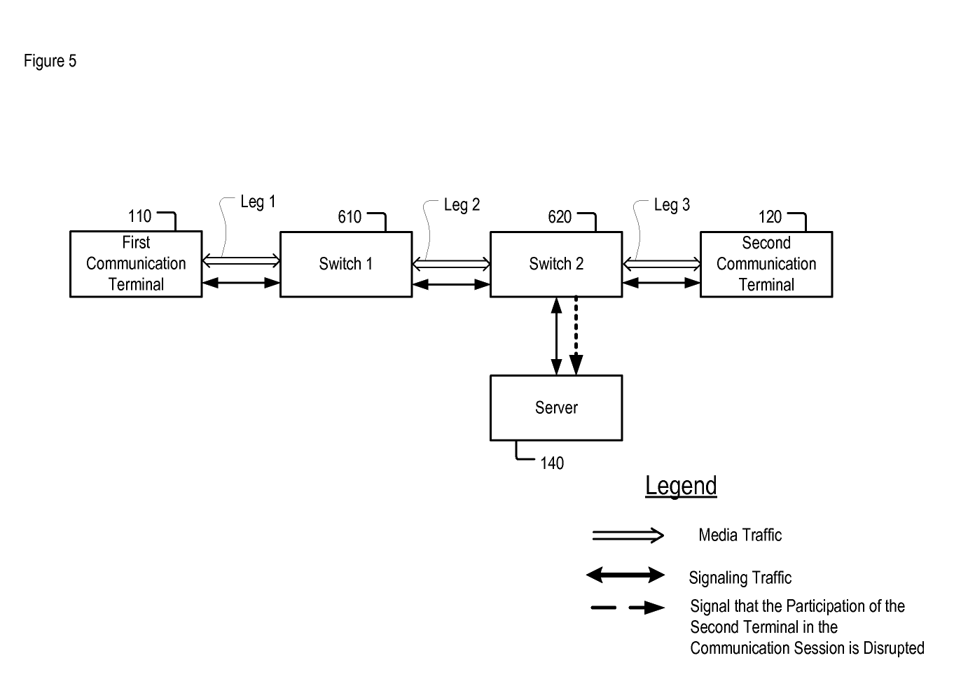

The use of connection setup application 280 by the present invention is optional. In alternative embodiments of the present invention, the communication session between terminal 110 and 120 is established without the involvement of connection setup application 280. (See, e.g., the discussion with respect to FIG. 5, etc.)

System software 260 is operating system software. It provides an interface between the hardware components of server 140 and the software components of server 140 (e.g., connection preservation application 290, etc.).

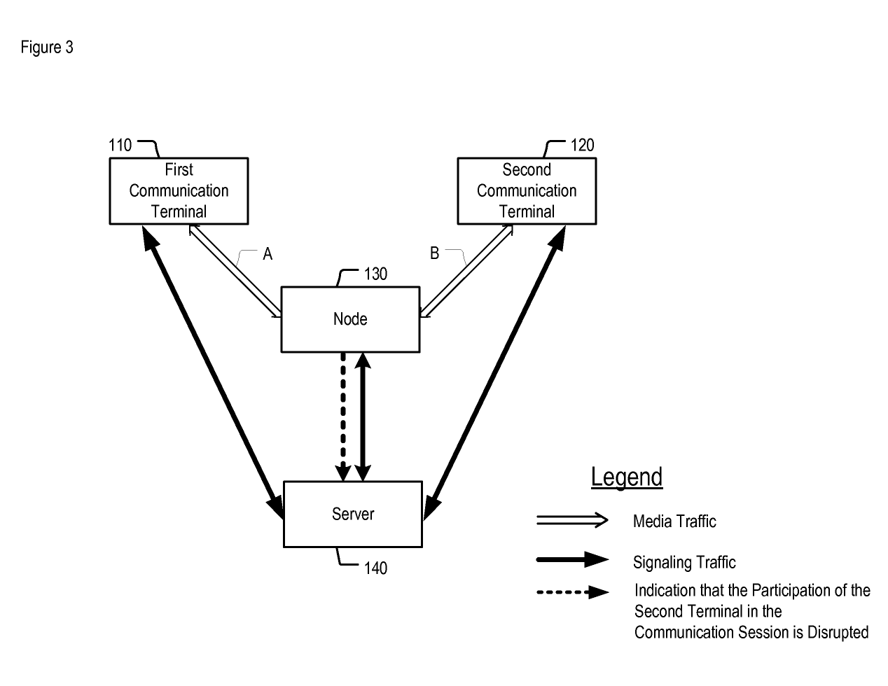

FIG. 3 depicts a schematic diagram of the data and signal flows which are exchanged between terminal 120 and terminal 110 in accordance with the illustrative embodiment of the present invention. As noted, in the illustrative embodiment, node 130 is a conference bridge.

Node 130 establishes the connection between terminal 110 and 120 in response to instructions from server 140 (via connection setup application 280 and/or connection preservation application 290). In particular, node 130 executes one or more of the following tasks when establishing the connection:
(1) Instantiating a conference call in response to instruction(s) from server 140.
(2) Providing server 140 with contact information for the instantiated conference call.
(3) Participating in communication session A with terminal 110,
(4) Participating in communication session B with terminal 120, and
(5) Bridging communication session A with communication session B.
(6) Performing any other action that is attributed to node 130 in this disclosure.

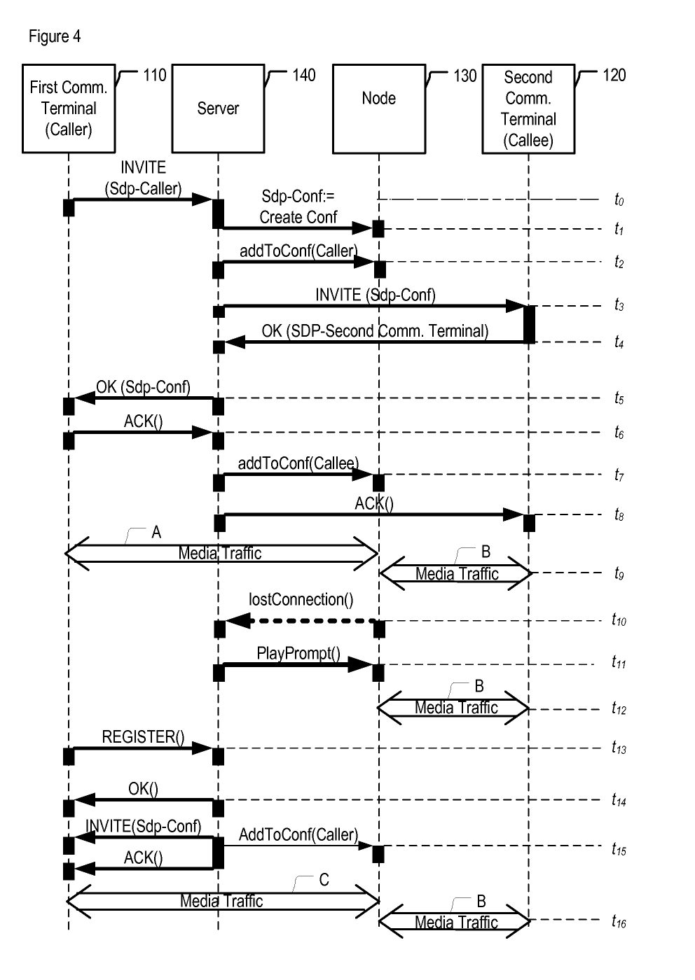

The connection-persistence capabilities of the illustrative embodiment are achieved by server 140. In particular, server 140, through connection setup application 280 and/or connection preservation application 290, executes one or more of the following tasks:
(1) Instructing node 130 to instantiate a conference call,
(2) Obtaining contact information for the instantiated conference call (e.g., IP address and port number that are needed by terminals 110 and 120 in order to join the conference call, etc.).
(3) Substituting the contact information for terminal 110 and 120, that is contained inside signaling messages transmitted by the terminals, with the contact information of the conference call, thereby causing terminals 110 and 120 to connect to node 130 (which is the conference call host) instead of to each other.
(4) Receiving an indication that the participation of terminal 110 in the communication session with terminal 120 is disrupted.
(5) Determining whether the communication session was terminated unexpectedly.
(6) Instructing node 130 to put terminal 120 on hold when the communication session is terminated unexpectedly.
(7) Instructing node 130 to put terminal 120 on hold when a directive for determining whether to put terminal 120 on hold applies.
(8) Facilitating the establishment of communication session C (See, e.g. FIG. 4, etc.) between node 130 and terminal 110.
(9) Instructing node 130 to bridge communication session C with communication B.
(10) Performing any other action that attributed to server 140 in this disclosure.

The solid arrows depicted in FIG. 3 illustrate the flow of signaling that is used for the establishment of a communication session between terminal 110 and terminal 120. In particular, session Initiation Protocol (SIP) signaling is exchanged between terminal 110 and terminal 120 via server 140. The signaling is used to negotiate the ports, codecs, and other parameters necessary for the setting of the connection between terminal 110 and terminal 120.

The communication session between terminal 110 and terminal 120 is set up as a conference call. The conference call is instantiated by node 130 in response to instructions from server 140. Server 140 generates the instructions for node 130 on the basis of the Session Initiation Protocol (SIP) signaling that is exchanged between the two terminals. In some embodiments, server 140 uses the information that is carried in the Session Initiation Protocol (SIP) messages to instruct node 130 on how to establish the teleconference (e.g., identify codecs for the conference, identify type of media (i.e., video, voice), etc.).

As noted, node 130 establishes the conference call pursuant to instructions from server 140. Eventually, after the conference call is established, terminal 110 experiences a failure. The failure causes the participation of terminal 110 in the conference call to be disrupted. In particular, the failure causes communication session A to be terminated. Exemplary failures include software failure, loss of signal, deterioration of signal, hardware failure, etc.

Node 130 detects when the participation of terminal 110 in the communication session with terminal 110 is disrupted. When node 130 ceases to receive media, it transmits an indication that the participation of terminal 110 in the communication session with terminal 120 is disrupted. The indication is transmitted to server 140.

Upon receiving the indication, server 140 instructs node 130 to maintain communication session B after communication session A is terminated. Node 130 executes the instruction and puts terminal 120 on hold.

Shortly after, terminal 110 recovers from the software failure and re-registers with network 150 by sending one or more registration messages to server 140. The message(s) which terminal 110 sends inform server 140 that terminal 110 is available to participate in communications once again.

After server 140 is informed that terminal 110 is again available to participate in communications, server 140 instructs node 130 to establish communication session C with terminal 110 (See, e.g., FIG. 4, etc.). Additionally, server 140 instructs node 130 to bridge communication session C with communication session B.

FIG. 4 depicts a sequence diagram of the interactions between terminal 110, server 140, node 130, and terminal 120 which take place in the illustrative embodiment of the present invention.

At time t₀, terminal 110 transmits an INVITE message directed to terminal 120. The INVITE message is received by server 140. In accordance with the illustrative embodiment, the INVITE message contains contact information for terminal 110. The contact information, in the illustrative embodiment, is information that is carried inside a Session Description Protocol (SDP) message. The SDP message is encapsulated inside the INVITE message. The contact information for terminal 110 is denoted “Sdp-Caller” in the sequence diagram.

At time t₁, in response to receiving the INVITE message, server 140 instructs node 130 to start a new conference call. Server 140 remotely executes a routine which causes node 130 to instantiate a new conference call and return contact information for the conference call. The contact information for the conference call is denoted “Sdp-Conf” in the sequence diagram.

In the illustrative embodiment, the contact information is encapsulated inside a Session Description Protocol (SDP) message. The contact information Sdp-Conf constitutes information which terminals 110 and terminal 120 need to possess in order to join the conference call (e.g., IP address of node 130, port number for the conference, etc.). In alternative embodiments of the present invention, the contact information need not be carried inside SDP messages.

At time t₂, server 140 instructs node 130 to add terminal 110 as a participant to the conference call.

At time t₃, server 140 modifies the INVITE message received at time t₀ and forwards the modified message to terminal 120. Server 140 modifies the message by substituting the SDP message that is originally found in the INVITE message with the SDP message for the conference call that is received at task t₁.

In accordance with the illustrative embodiment of the present invention, the contact information for user 110 is substituted with contact information for node 130 (i.e., the conference call contact information, etc.) by completely replacing the original SDP message found in the INVITE with the SDP message for the conference call. It will be clear to those skilled in the art, after reading this disclosure, how to make and use alternative embodiments of the present invention in which individual items of information that are found in the original SDP message are substituted. Furthermore, it will be clear to those skilled in the art, after reading this disclosure, that in embodiments of the present invention which use other protocols (e.g., H.323, SS7, etc.), SDP messages are not used at all. It will be clear to those skilled in the art how to identify and substitute relevant contact information item(s) according to the principles and methods described in this disclosure.

At time t₄, terminal 120 transmits an OK message indicating that it accepts the invitation to participate in a communication session with terminal 110. The OK message contains contact information for terminal 120. The contact information for terminal 120 is denoted “Sdp-Callee” in the sequence diagram. Again, because the present invention uses SIP, the contact information is found inside an SDP message that is encapsulated inside the SIP message. In alternative embodiments of the present invention, the contact information need not be carried inside SDP messages.

At time t₅, server 140 modifies the OK message received at task t₄ and forwards the modified OK message to terminal 110. Server 140 modifies the OK message by substituting the contact information for terminal 120 that is found in the message with the contact information for the conference call. The OK message is modified according to the principles described with respect to the modification of the INVITE message at time t₄.

At time t₆, terminal 110 transmits an ACK message to server 140.

At time t₇, server 140 instructs node 130 to add terminal 120 to the conference call.

At time t₈, server 140 forwards the ACK message transmitted at time t₆ to terminal 120.

At time t₉, communication session A and communication session B are established. Communication session A is between terminal 110 and node 130. Communication session B is between terminal 120 and node 130. Additionally, at time t₉, the two sessions are bridged by node 130.

At time t₁₀, server 140 receives an indication that the participation of terminal 110 in the communication session with terminal 120 is disrupted. The indication is transmitted by node 130. In accordance with the illustrative embodiment of the present invention, the trigger for the transmittal of the indication is loss of media from terminal 110. Moreover, in the illustrative embodiment, the media is lost because connection A is terminated. The cause of the termination can be a software or hardware failure of terminal 110, loss of signal, etc.

At time t₁₁, server 140 instructs node 130 to put terminal 120 on hold. Furthermore, server 140 instructs node 130 to play a prompt to terminal 120. The prompt serves to inform the user of terminal 120 that he or she is being put on hold.

At time t₁₂, terminal 120 is put on hold. By putting terminal 120 on hold, server 140 keeps communication session B active. In other words, connection B is not torn down after the loss of media from terminal 110 is experienced.

At time t₁₃, terminal 110 reconnects to network 150 and re-registers with server 140.

At time t₁₄, server 140 transmits an OK message to terminal 110.

At time, t₁₅, in response to the re-registering of terminal 110, server 140 transmits an INVITE and ACK message to terminal 110 and instructs node 130 to add terminal 110, for a second time, to the conference call that was initialized at time t₁. The INVITE message contains the contact information of the conference.

At time t₁₆, communication session C between terminal 110 and node 130 is established. The new communication session is denoted “communication session C” in the sequence diagram. Communication session C is bridged with communication session B by node 130. After the communication sessions are bridged, terminal 120 is removed from being on hold.

FIG. 5 depicts a schematic diagram of the data flows which are exchanged between terminal 120 and terminal 110 in accordance with a first alternative embodiment of the present invention.

The connection between terminal 110 and 120 is established as an ordinary telephone call in which terminal 110 dials the number of terminal 120 and, in response, is connected to terminal 120 by the telephone service provider. In other words, in the first alternative embodiment, the connection between terminal 110 and 120 is not set up as a conference call.

In the accordance with the first alternative embodiment of the present invention, a connection oriented communication session is established between terminal 110 and terminal 120. The communication link between terminal 110 and terminal 120 uses a communication path which spans switch 610 and switch 620. Switch 620 is capable of generating indication that the participation of terminal 110 in the communication session is disrupted. Also, switch 620 is capable of placing terminal 120 on hold in response to instruction(s) from server 140.

The communication path comprises three legs: leg 1, leg 2, and leg 3. Each leg is characterized by the allocation of resources (e.g., time slots, ports, etc.) of switch 610 and switch 130. The resources are allocated to assure the quality-of-service of the communication link between terminal 110 and terminal 120.

Ordinarily, the resources allocated to leg 1, leg 2, and leg 3 are de-allocated when the communication link between terminal 110 and terminal 120 is terminated. In accordance with the first alternative embodiment of the present invention, when the communication session is terminated unexpectedly, leg 3 is kept active, after leg 1 and leg 2 are de-allocated. Leg 3 is kept active for connection preservation purposes.

Unexpected termination is considered to have occurred when switch 620 stops receiving media over leg 2 without there being an indication that terminal 110 hung up intentionally. Moreover, unexpected termination is considered to have occurred when switch 620 starts receiving media that is corrupt or when a quality of service measure of the data that is transmitted over leg 2 (e.g., jitter, latency, etc.) falls below a predetermined threshold. When the participation of terminal 110 is disrupted, switch 620 notifies server 140.

Upon receiving the notification, server 140 instructs switch 620 to the keep Leg 3 active and put terminal 120 on hold. In some embodiments, switch 620 is also instructed to transmit a prompt to terminal 120 informing the terminal that it is being put on hold.

FIG. 6 depicts a flowchart of the execution of the salient tasks associated with the operation of the illustrative embodiment of the present invention.

At task 610, server 140 receives a request from terminal 110 to establish a direct connection with terminal 120. In the illustrative embodiment, the Session Initiation Protocol (SIP) is used. In alternative embodiments of the present invention, other signaling protocols are used (e.g., H.323, ss7, etc.).

In accordance with the illustrative embodiment of the present invention, the request identifies a Session Initiation Protocol (SIP) uniform resource identifier (URI). The URI belongs to a party to which terminal 110 is trying to connect. The URI is resolved to an address of terminal 120 (e.g., IP address, etc.) by server 140 and/or other components of network 150. Thus, terminal 120 is an endpoint device for the SIP URI that is identified in the INVITE message. Node 130, on the other hand, is not an endpoint device associated with the SIP URI.

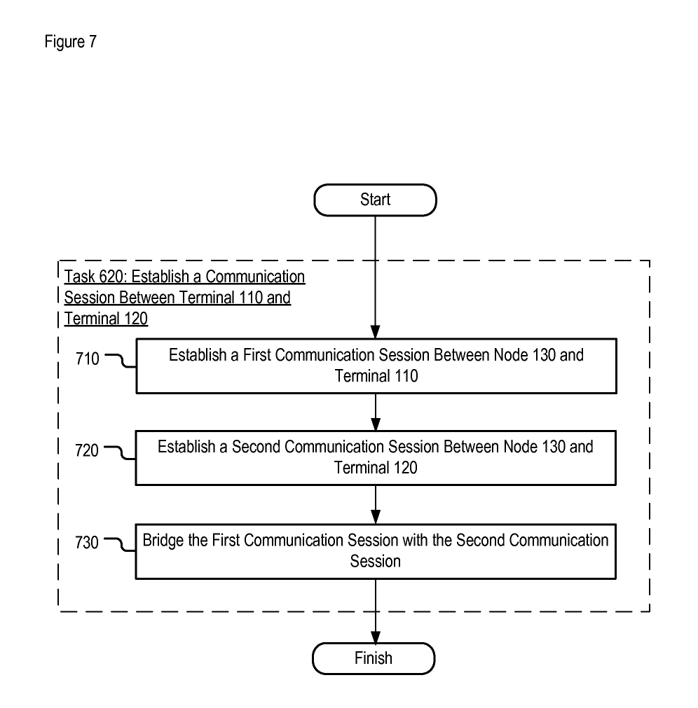

At task 620, a communication session between terminal 110 and terminal 120 is established. In accordance with the illustrative embodiment, the communication session is a voice call. In alternative embodiments of the present invention, however, the communication session is of another type (e.g., video call, real-time text chat, etc.). Task 620 is further described in the discussion with respect to FIG. 7.

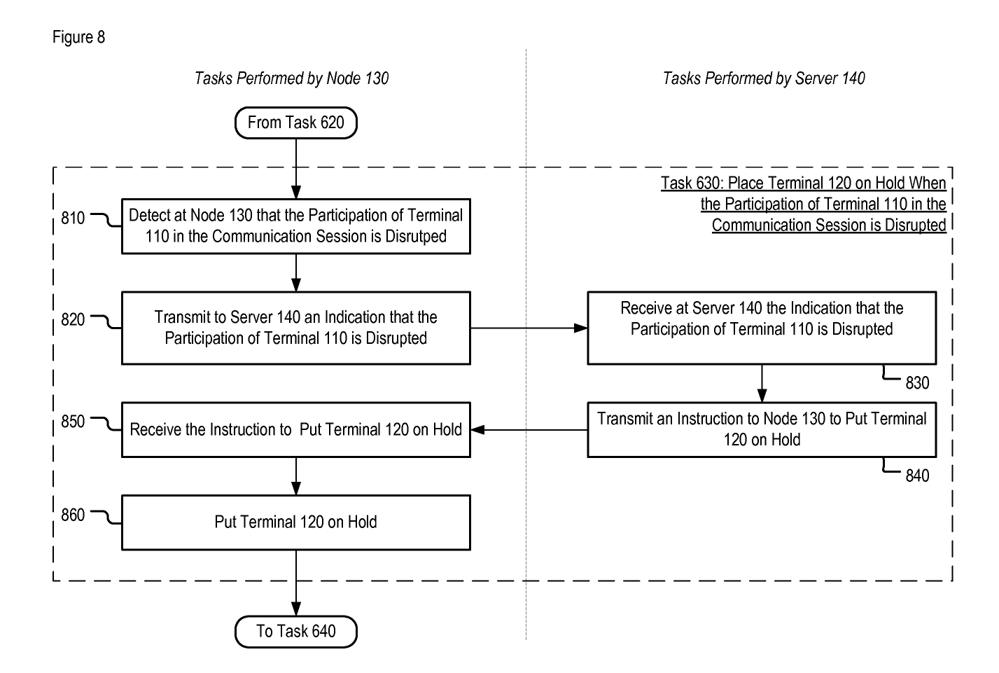

At task 630, terminal 120 is put on hold when the participation of terminal 110 in the communication session is disrupted. Task 630 is further described in the discussion with respect to FIG. 8.

At task 640, connection preservation application 290 determines that terminal 110 is available to reconnect to terminal 120. In the illustrative embodiment of the present invention, connection preservation application 290 monitors registration requests that are issued to network 150. Specifically, connection preservation application 290 monitors SIP register messages that are received at server 140 or other components of network 150. When a SIP REGISTER message from terminal 110 is received, connection preservation application 290 determines that terminal 110 is available for communications.

In an alternative embodiment, connection preservation application 290 takes an alternative approach to determining whether terminal 110 is available for communications. In the alternative embodiment, connection preservation application 290 pings terminal 110 shortly after receiving the indication that the participation of the terminal in the communication is disrupted. If terminal 110 responds, connection preservation application 290 determines that terminal 110 is available for communications.

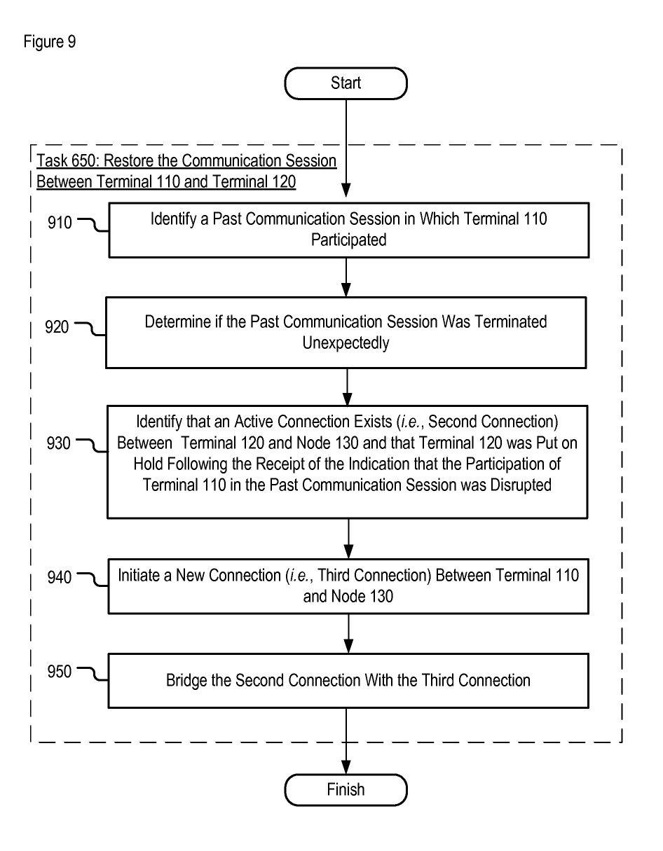

At task 650, the communications session between terminal 110 and terminal 120 is restored. Terminal 110 is connected to the put-on-hold terminal 120. In accordance with the illustrative embodiment of the present invention, communications session C is started and bridged with communications session B. Task 650 is further described in the discussion with respect to FIG. 9.

Tasks 610-650 are described for illustrative purposes. It will be clear to those skilled in the art, after reading this disclosure, how to perform the tasks associated with FIG. 6 in a different order than represented or to perform one or more of the tasks concurrently. Furthermore, it will be clear to those skilled in the art, after reading this disclosure, how to make and use alternative embodiments of the present invention that omit one or more of the tasks.

FIG. 7 depicts a flowchart of the execution of the salient sub-tasks associated with the performance of task 620.

As discussed with respect to FIGS. 6 and 4, at task 620, a connection is established between terminal 110 and 120. The connection is established by connection setup application 280. In establishing the connection, connection setup application 280 performs two salient functions: (1) it provides terminal 110 and terminal 120 with the contact information of node 130 (i.e., the contact information of the conference call that is instantiated at node 130); and (2) it instructs node 130 to set up the conference call with terminal 110 and terminal 120 as participants.

The communication session between terminal 110 and 120 is set up following the request to establish a direct communication session with terminal 120. The request is transmitted by terminal 110. In response to this request, terminal 110 receives the contact information of node 130 (or more precisely, contact information for a conference call that is hosted by node 130) and not that of terminal 120. Put differently, connection setup application 280, substitutes the contact information of terminal 120 with the contact information of node 130 in the Session Initiation Protocol (SIP) message(s) that are exchanged between terminal 110 and terminal 120. The substitution is performed transparently. While the connection is being established, and after, terminal 110 is unaware that it is being connected to node 130 rather than terminal 120. From the viewpoint of terminal 110, the connection setup is performed in the same manner as a non-conference call with terminal 120.

Similarly, connection setup application 280, substitutes the contact information of terminal 110 with the contact information of node 130 in the Session Initiation Protocol (SIP) message(s) that are exchanged between terminal 110 and terminal 120. The substitution is performed transparently. While the connection is being established, and after, terminal 120 is unaware that it is being connected to node 130 rather than terminal 110.

After terminal 110 and terminal 120 are provided with the contact information of node 130, terminal 110 is connected with terminal 120 in the manner described with respect to tasks 710-730.

At task 710, communication session A is established between terminal 110 and node 130.

At task 720, communication session B is established between terminal 120 and node 130.

At task 730, node 130 bridges communication session A with communication session B. When communication session B is bridged with communication session A, media which is received by node 130 over communication session A is forwarded to terminal 120 over communication session B. Similarly, media received by node 130 over communication session B is forwarded to terminal 110 over communication session A.

Tasks 710-730 are described for illustrative purposes. It will be clear to those skilled in the art, after reading this disclosure, how to perform the tasks associated with FIG. 7 in a different order than represented or to perform one or more of the tasks concurrently. Furthermore, it will be clear to those skilled in the art, after reading this disclosure, how to make and use alternative embodiments of the present invention that omit one or more of the tasks.

FIG. 8 depicts a flowchart of the execution of the salient sub-tasks associated with the performance of task 630.

At task 810, node 130 determines that the participation of terminal 110 in the communication session with terminal 120 is disrupted. Node 130 determines that the participation of terminal 110 is disrupted when one of the following triggering events occurs:
(1) media from terminal 110 is lost (e.g., node 130 stops receiving voice packets from terminal 120, etc.),
(2) node 130 receives one or more packets that are corrupt,
(3) a quality-of-service attribute (e.g., latency, jitter, etc.) of the communications session between node 130 and terminal 110 falls below a threshold, and.
(4) any other event described in this disclosure.

At task 820, node 130 transmits to server 140 an indication that the participation of terminal 110 in the communication session is disrupted. In some embodiments of the present invention, the indication contains the reason for the disruption (e.g., loss of media, excessive jitter, corrupt packets, etc.). In further embodiments, the indication contains the value of a quality-of-service measure or a error rate (e.g., 60% of received packets are corrupt, 5 ms latency, etc.)

At task 830, node 140 receives the indication that the participation of terminal 110 in the communication session is disrupted.

At task 840, connection preservation application 290 transmits an instruction to node 130 to put terminal 120 on hold. The instruction is transmitted in response to the receipt of the indication that the participation of terminal 110 in the communication session with terminal 120 is disrupted.

In the first alternative embodiment of the present invention, connection preservation application 290 determines whether to instruct node 130 to put terminal 120 on hold according to a directive that is stored in the memory of server 140. In accordance with the alternative embodiment, the directive depends on information that is contained in the indication received at task 830 and/or the identity of the terminal whose participation is disrupted. Examples of such directives include:
(1) Put terminal 120 on hold only if percentage of corrupt packets exceeds 55%.
(2) Put terminal 120 on hold if latency exceeds 4 ms.
(3) Put terminal 120 on hold if the participation of terminal 110 is disrupted, but do not put terminal 110 on hold when the participation of terminal 120 is disrupted.
(4) Put terminal 120 on hold if media from terminal 110 is low without there being a Session Initiation Protocol (SIP) BYE message received by server 140.

In a second alternative embodiment of the present invention, connection preservation application 290 determines whether the communication session between terminal 110 and 120 was terminated unexpectedly by terminal 110. Unexpected termination is unintentional termination which can be triggered by a range of events such as software failure, hardware failure, loss of coverage, etc. Expected termination, on the other hand, is termination that occurs after a user willfully hangs up. Generally, when a user willfully hangs up, a signaling message, such as a SIP BYE message, is generated. Connection preservation application 290 monitors whether message(s) that indicate willful termination are generated by terminal 110 during a time period which overlaps or follows the time when terminal 110 stops transmitting media (e.g., 30 seconds before and 30 seconds after, 60 seconds after, etc.). In the illustrative embodiment, connection preservation application 290 monitors whether such messages are received by server 140. In alternative embodiments, connection preservation application 290 determines whether the messages are received at other nodes of network 150 either by communicating with the nodes directly or by monitoring traffic that is flowing trough network 150.

If a message that indicates willful termination is generated, connection preservation application 290 determines that terminal 110 intentionally terminated the connection and does not issue an instruction to put terminal 120 on hold. Conversely, if a message that indicates willful termination is not detected, connection preservation application 290 determines that the connection was terminated unexpectedly and instructs node 130 to put terminal 120 on hold.

At task 850, node 130 receives the instruction to put terminal 120 on hold.

At task 860, in response to the receipt of the instruction, node 130 puts terminal 120 on hold. In some embodiments, terminal 120 is put on hold for a predetermined time-out period (e.g., 1 minute, etc.). If the period expires prior to terminal 110 becoming again available for communications, communication session B is terminated. It will be clear to those skilled in the art how to execute task 860.

In further embodiments of the present invention, node 130 transmits a message to terminal 110 (e.g., a voice prompt, etc.) indicating that the terminal is being put on hold.

Tasks 810-860 are described for illustrative purposes. It will be clear to those skilled in the art, after reading this disclosure, how to perform the tasks associated with FIG. 8 in a different order than represented or to perform one or more of the tasks concurrently. Furthermore, it will be clear to those skilled in the art, after reading this disclosure, how to make and use alternative embodiments of the present invention that omit one or more of the tasks.

FIG. 9 depicts a flowchart of the execution of the salient sub-tasks associated with the performance of task 650.

At task 910, connection preservation application 290 identifies a past communication in which terminal 110 participated. In accordance with the illustrative embodiment of the present invention, connection preservation application 290 consults information in database 370 and identifies that terminal 110 communicated with terminal 120.

At task 920, connection preservation application 290 consults database 370 determines that the communication of terminal 110 with terminal 120 was unexpectedly terminated.

At task 930, connection preservation application 290 consults database 370 and determines that terminal 120 is put on hold. Also, it determines that communications session B is still active.

At task 940, communications session C between terminal 110 and node 130 is established.

At task 950, node 130 to bridges communication session B with communication session C. After the two communication sessions are bridged, terminal 110 can resume its communications with terminal 120.

Tasks 910-950 are described for illustrative purposes. It will be clear to those skilled in the art, after reading this disclosure, how to perform the tasks associated with FIG. 9 in a different order than represented or to perform one or more of the tasks concurrently. Furthermore, it will be clear to those skilled in the art, after reading this disclosure, how to make and use alternative embodiments of the present invention that omit one or more of the tasks.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
(A) establishing a conference in response to a request to establish a direct communication session, wherein the establishing task comprises the following subtasks:
establishing a first communication session between a network node and a first communication terminal,
establishing a second communication session between the network node and a second communication terminal, and
bridging the first communication session with the second communication session;
(B) placing the second communication terminal on hold when receipt of media by the network node over the first communications session is disrupted, wherein task A and task B are executed by the network node.

2. The method of claim 1 wherein the request to establish a direct call is a Session Initiation Protocol (SIP) INVITE message.

3. The method of claim 1 wherein the second user is put on hold when the network node stops to receive media over the first connection.

4. The method of claim 1 wherein the second user is put on hold when a quality of service measure of the first communications session falls below a threshold.

5. The method of claim 1 wherein the network node is a conference bridge.

6. A method comprising:
establishing a communication session between a first communication terminal and a second communication terminal;
receiving, at a first server, an indication that participation of the first communication terminal in the communication session is disrupted, wherein the indication is transmitted by a network node;
transmitting from the first server to the network node, an instruction to place the second communication terminal on hold; and
placing the second communication terminal on hold when the instruction is received by network node.

7. The method of claim 6 further comprising transmitting from the network node to the second communication terminal a message indicating that the second communication terminal is put on hold.

8. The method of claim 6 comprising terminating the connection between the network node and the second communication terminal after a time-out period expires.

9. The method of claim 6 comprising connecting the first communication terminal to the second communication terminal in response to the receipt, at the first server, of an indication that the first communication is available to resume its communication with the second communication terminal.

10. The method of claim 6 wherein the indication is a request by the first communication terminal to register on a communication network.

11. A method comprising:
receiving, at a server, a message that indicates that a first communication terminal is able to participate in communications, wherein:
(a) the server is part of a communication network;
(b) the first communication terminal is disconnected from the communication network at time t₁, and
(c) the message is received at time t₂, wherein t₁<t₂;
in response to the receipt of the message, identifying, at the server, a communication session between the first communication terminal and a second communication terminal, wherein:
(a) the first communication session comprised a second communication session between a node on the communication network and the first communication terminal and a third communication session between the first server and the second communication terminal, wherein the second communication session and the third communication session were bridged to form the first communication session, and
(b) the second communication terminal participated in the first communication session at time t₀, wherein t₀<t₁;
when the second communication session is still in existence, establishing a fourth communication session between the first communication terminal and the node; and
bridging the fourth communication session to the second communication session.

12. The method of claim 11 wherein the node is a conference bridge.

13. The method of claim 11 wherein the server is a Session Initiation Protocol (SIP) server.

14. The method of claim 11 wherein the message indicating that the first communication terminal is available to participate in communications is a Session Initiation Protocol (SIP) REGISTER message.

15. The method of claim 11 wherein the first communication session was established in response to a request to establish a direct communication session.

16. A method comprising:
receiving, at a server, a request from a first communication terminal to establish a direct communication session between the first communication terminal and a second communication terminal;
instructing, a conference bridge to instantiate a conference call;
receiving, at the server, from the conference bridge, contact information for the instantiated conference call;
substituting contact information of the first terminal that is contained in the request with contact information for the conference call; and
forwarding the request with the substituted contact information to the second terminal;
wherein the receiving and substituting tasks are executed by the server.

17. The method of claim 16 wherein the request to establish a direct communication session is a Session Initiation Protocol (SIP) invite message.

18. The method of claim 16 comprising:
receiving, at the server from the second communication terminal, a response to the request;
substituting contact information for the second terminal that is found in the response to the request with contact information for the conference call;
forwarding the response with the substituted contact information to the first terminal.

19. The method of claim 16 wherein the conference bridge is instructed to instantiate the conference call in response to receiving the request to establish the direct communication session.
